(19) United States
(12) Patent Application Publication
(10) Pub. No.: US 2009/0112589 A1
(43) Pub. Date: Apr. 30, 2009

(54) ELECTRONIC APPARATUS AND SYSTEM WITH MULTI-PARTY COMMUNICATION ENHANCER AND METHOD

(76) Inventors: Per Olof Hiselius, Lund (SE); Jonas Magnus Andersson, Tokyo (JP)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/928,202

(22) Filed: Oct. 30, 2007

(51) Int. Cl. G10L 17/00

(52) U.S. Cl. 704/246; 704/E17.003

(57) ABSTRACT

A multi-party communication enhancer includes an audio data input adapted to receive voice data associated with a plurality of communication participants. A participant identifier included in the multi-party communication enhancer is adapted to distinguish the voice of a number of communication participants as represented within the received voice data. A cue generator, also included in the multi-party communication enhancer, is operable to generate a cue for each distinguished voice, with the generated cue being outputted in association with the corresponding distinguished voice.

### TECHNICAL FIELD OF THE INVENTION

The present invention relates generally to voice communications, and more particularly to an apparatus and system for carrying out multi-party communications, e.g., “conference calls.”

### DESCRIPTION OF THE RELATED ART

Voice communications via telephony have become a fundamental part of everyday life. Whether for business or pleasure, most people have come to rely on telephony to allow them to conduct their daily affairs, keep in contact with each other, carry out business, etc. Moreover, with the increasing development of digital telephony it has become possible to carry out high speed voice and data communications over the internet, within mobile networks, etc.

Multi-party communications, e.g., “conference calls,” have long been available within conventional telephone networks and now within the new high speed digital networks. Conference calls allow multiple participants and multiple locations to participate simultaneously in the same telephone call. Thus, for example, in addition to a standard calling party and receiving party, additional parties may join in the telephone call. Conference calls are particularly useful for carrying on business meetings over the telephone, avoiding the need for each of the parties to meet in person or to call each other individually.

Multi-party communications do suffer from some drawbacks. For example, conference calls tend to become confusing when the number of participants grows. A listening party may have trouble differentiating between the voices of the other participants. Other than the voice of the participant currently speaking, a listening party receives no other indication as to the identity of the speaker. This can be inconvenient in that it causes participants to focus more on determining which person is currently speaking, and less on what is actually being said. Also, a listening party may have difficulty hearing what is being said when the participants are situated at different distances from the microphone or speak with different strong voices.

### SUMMARY

In accordance with an aspect of the invention, participants in a multi-party communications are better able to differentiate between participants. According to another aspect, listeners in such multi-party communications are better able to concentrate on the topic of discussion, rather than concentrating on determining the identity of the speaker.

In accordance with yet another aspect of the invention, a multi-party communication enhancer is provided including an audio data input adapted to receive voice data associated with a plurality of multi-party communication participants. The multi-party communication enhancer further includes a participant identifier adapted to distinguish the voice of a number of communication participants as represented within the received voice data. A cue generator, also included in the multi-party communication enhancer, is operable to generate a cue for each distinguished voice, the generated cue being outputted in association with the corresponding distinguished voice.

In accordance with still another aspect, the multi-party communication enhancer includes an amplitude normalizer adapted to selectively normalize the volume level of the received voice data.

According to another aspect of the invention, the multi-party communication enhancer provides that the participant identifier includes a voice recognizer.

According to yet another aspect, the multi-party communication enhancer provides that the cue generator includes at least one of a graphic cue generator or an audio cue generator.

In accordance with still another aspect of the invention, the multi-party communication enhancer provides that the audio cue generator includes a multi-party spatializer adapted to generate an audio cue that provides a virtual spatial location from which the corresponding distinguished voice appears to originate when reproduced. The multi-party communication enhancer further provides that the graphic cue generator generates a graphic cue that graphically represents the corresponding virtual spatial location provided by the audio cue.

In accordance with another aspect, the multi-party communication enhancer provides that the audio cue generator generates an audio cue that is at least one of a vocal cue or a tonal cue. The multi-party communication enhancer further provides that the graphic cue generator generates a graphic cue that is at least one of a character, a combination of characters, an icon, or a color.

In accordance with yet another aspect, the multi-party communication enhancer provides that the graphic cue generator provides a graphic cue for each communication participant and at least one of the provided graphic cues is highlighted to indicate which communication participant is speaking.

According to another aspect of the invention, the multi-party communication enhancer provides that the participant identifier designates speaker identification data for each distinguished voice to provide the corresponding cue.

According to still another aspect, the multi-party communication enhancer provides that the speaker identification data is at least one of user-provided data, data assigned by the participant identifier, data received in association with the received voice data, data regarding the time of joining the multi-party communication, data regarding the order in which the voice was distinguished by the participant identifier, or data regarding the number of participants in the multi-party communication.

In accordance with another aspect of the invention, a method for discerning respective participants in a multi-party communication includes receiving voice data associated with a plurality of communication participants and distinguishing the voice of a number of the communication participants as represented within the received voice data. The method further includes correspondingly generating a cue for each distinguished voice and outputting the generated cue in association with the corresponding distinguished voice.

In accordance with yet another aspect, the method for discerning respective participants further includes selectively normalizing the volume level of the received voice data.

According to still another aspect of the invention, the method for discerning respective participants provides that distinguishing the voice of a number of communication participants includes using voice recognition technology.

With still another aspect, the method for discerning respective participants provides that correspondingly generating a cue includes generating at least one of a graphic cue or an audio cue.

According to yet another aspect, the method for discerning respective participants provides that generating an audio cue includes providing a virtual spatial location from which the corresponding distinguished voice appears to originate when reproduced. The method further provides that generating a graphic cue includes graphically representing the corresponding virtual spatial location provided by the audio cue.

In accordance with another aspect, the method for discerning respective participants provides that distinguishing the voice of a number of communication participants includes designating speaker identification data for each distinguished voice to provide the corresponding cue.

In accordance with still another aspect, the method for discerning respective participants provides that designating speaker identification data includes providing at least one of user-provided data, data assigned by the participant identifier, data received in association with the received voice data, data regarding the time of joining the multi-party communication, data regarding the order in which the voice was distinguished by the participant identifier, or data regarding the number of participants in the multi-party communication.

In accordance with another aspect of the invention, an electronic device includes an audio data input, adapted to receive voice data associated with a plurality of communication participants, and a multi-party communication enhancer as described above. The received voice data is input to the multi-party communication enhancer.

With still another aspect, the electronic device further includes at least one of a conventional audio processor, a stereophonic audio system, or a display.

With yet another aspect, the electronic device further includes an amplitude normalizer adapted to selectively normalize the volume level of the received voice data.

In still another aspect, the electronic device provides that the participant identifier includes a voice recognizer.

In accordance with another aspect, the electronic device provides that the cue generator includes at least one of a graphic cue generator or an audio cue generator.

According to yet another aspect of the invention, the electronic device provides that the audio cue generator includes a multi-party spatializer adapted to generate an audio cue that provides a virtual spatial location from which the corresponding distinguished voice appears to originate when reproduced. The electronic device further provides that the graphic cue generator generates a graphic cue that graphically represents the corresponding virtual spatial location provided by the audio cue.

In accordance with another aspect, the electronic device provides that the participant identifier designates speaker identification data for each distinguished voice to provide the corresponding cue.

According to still another aspect, the electronic device provides that the speaker identification data is at least one of user-provided data, data assigned by the participant identifier, data received in association with the received voice data, data regarding the time of joining the multi-party communication, data regarding the order in which the voice was distinguished by the participant identifier, or data regarding the number of participants in the multi-party communication.

With yet another aspect, the electronic device provides that the electronic device is a mobile phone.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

FIGS. 1A, 1B, 1C and 1D are schematic examples of graphic cues shown on a mobile phone display during a conference call in accordance with an embodiment of the present invention;

FIG. 2 is a functional block diagram of a multi-party communication enhancer in accordance with an embodiment of the present invention;

FIG. 3 is a schematic diagram representing the spatial locations of participants in a multi-party communication in accordance with an embodiment of the present invention;

FIG. 4 is a functional block diagram of a multi-party communication spatializer included in the audio cue generator of FIG. 2 in accordance with an embodiment of the present invention;

FIG. 5 is a functional block diagram of a mobile phone incorporating a multi-party communication enhancer in accordance with an embodiment of the present invention;

FIG. 6 is a perspective view of the mobile phone of FIG. 5 in accordance with an embodiment of the present invention;

FIG. 7A is a schematic diagram of a packet of combined voice data in accordance with an embodiment of the present invention;

FIG. 7B is a schematic diagram of a packet of multi-party voice and ID data in accordance with an embodiment of the present invention; and

FIG. 8 is a schematic diagram of a packet of multi-party voice data in accordance with an embodiment of the present invention.

### DETAILED DESCRIPTION OF EMBODIMENTS

The present invention discerns each speaking participant or party in a multi-party communication by providing cognitive feedback in addition to the voice of the speaking party. The cognitive feedback may include audio and/or graphic cues that are correspondingly generated or provided with the voice of respective speakers to assist the identification of participants during a multi-party communication. Using participant identification techniques according to the present invention, each speaking party may be distinguished, even when calling from the same location and using the same microphone. Each distinguished speaker is assigned a cue that is provided when the participant speaks. The generated cue may be arbitrarily designated or may be based on existing data, e.g., as is described below. In such manner, a listening party is able to discern the speaking participant in a multi-party communication, regardless of whether the exact identity of the speaker is known. Another aspect of the present invention improves the ability to hear each speaking participant during the multi-party communication by normalizing the amplitude of the received voice data so that the voices associated with the multi-party communication are reproduced at the same volume level.

In an exemplary embodiment of the present invention, a listening party participates in a multi-party communication, e.g., conference call, using generally conventional telephony equipment, such as a mobile phone or a landline telephone. The communication participants may be located at several different locations, and any given location may include one or more than one participant and may use one or more than one microphone. For example, in a conference call between two or more branch locations of a large corporation, there may be several participants at each location, with each participant speaking into an individual microphone. For purposes of explanation of the present invention, it is assumed, unless otherwise specified, that the listening party is participating in a conference call involving several participants (other than the listening party) located in one office using one microphone. This explanation is exemplary and it will be appreciated that the invention may be used with other numbers of locations and/or participants.

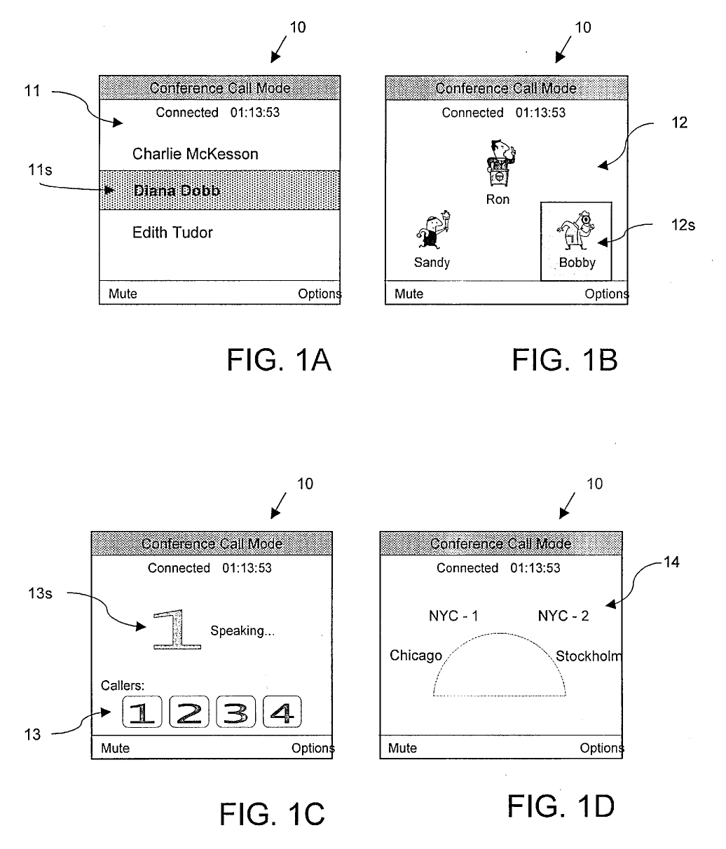

FIGS. 1A through 1D schematically illustrate four examples of graphic cues provided on a mobile phone display 10 to distinguish conference call participants in accordance with an exemplary embodiment of the present invention.

FIG. 1A illustrates a mobile phone display 10 that presents the names of three conference call participants in a list format 11, with the name of the speaking participant being highlighted at 11s. In the exemplary embodiment, when a participant speaks for the first time, a graphic cue is provided by displaying and highlighting the name of the speaker. When the participant stops speaking, her name continues to be displayed but is no longer highlighted. When a second participant begins to speak, his name is highlighted and is displayed along with the other participant's name in the list format 11. In this manner, the names of all three participants eventually appear on the display 10 in the list format 11, but only the name of the speaking participant is highlighted at any given time.

FIG. 1B illustrates a mobile phone display 10 that presents both an icon and a name for each of the three participants, e.g., as shown at 12. Similar to FIG. 1A, the name and icon of the speaking party are highlighted, e.g., at 12s, until the participant stops speaking. Also similar to FIG. 1A, the name and icon of each participant remain on display even after the participant stops speaking.

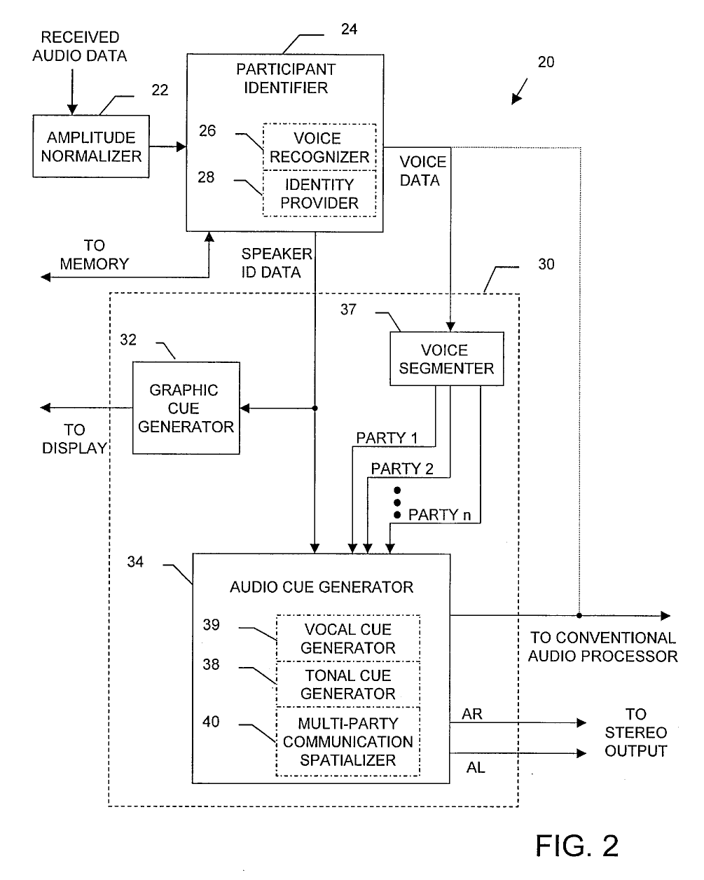

FIG. 1C illustrates a mobile phone display 10 that presents an arbitrary speaker label for each participant, e.g., as shown at 13. In accordance with an exemplary embodiment of the present invention, each participant has designated speaker identification data (e.g., a name and/or a photograph) that is used to generate a corresponding cue (as will be discussed in more detail with respect to FIG. 2 below). In the example of FIG. 1C, no speaker identification data is readily available for the participants and thus, the data is created by assigning an arbitrary speaker label to each participant (e.g., 1, 2, 3, and 4). The exemplary embodiment of FIG. 1C displays the assigned speaker labels 13 of all the participants at the bottom of the screen and emphasizes the speaking participant by placing her speaker label in large font in the center of the screen, e.g., at 13s. In such manner, a listening party may still distinguish between conference call participants even if the actual identity of the speakers is unknown.

In the exemplary embodiments of FIGS. 1A through 1C, the time at which a participant joins the conference call may determine the order in which the names are presented. Alternatively, other criteria may be used, as will be discussed below. Also, in the exemplary embodiments the name of each participant is displayed when the participant speaks for the first time. As such, if a participant does not speak during the entire conference call, no graphic cue may appear on the mobile phone display 10 for that participant. In another embodiment, if all participants are known before and/or as the conference call begins, corresponding graphic cues may be provided for all participants from the outset. According to yet another embodiment, the mobile phone display 10 may only present one graphic cue corresponding to the participant speaking at any given time, rather than continuously displaying graphic cues for all conference call participants.

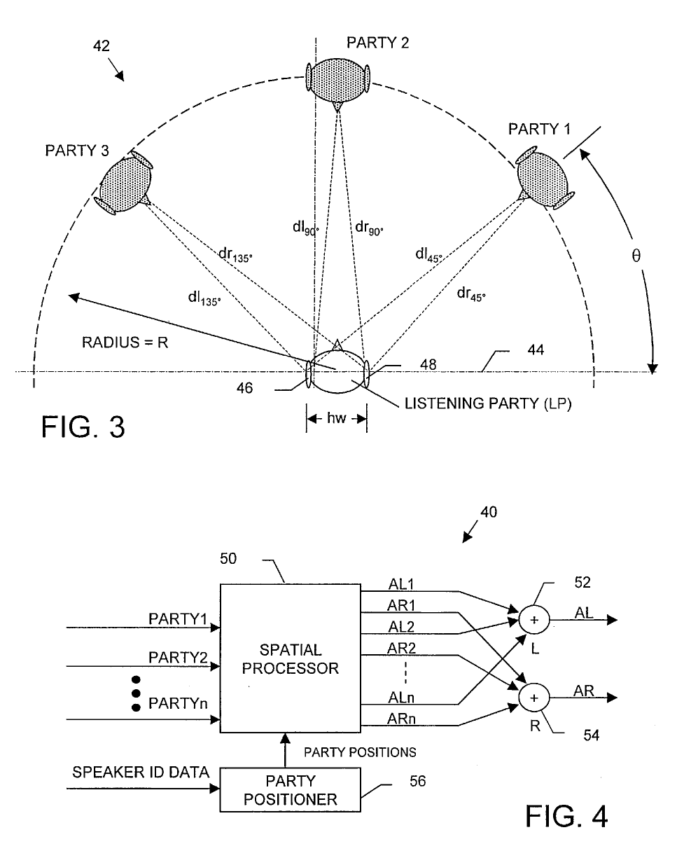

Referring to FIG. 1D, the illustrated mobile phone display 10 presents the geographical locations, e.g., at 14, of the conference call participants (e.g., Chicago, NYC-1, NYC-2, and Stockholm), where the four participants (other than the listening party) are calling from three office locations. That is, two of the participants are calling from the same office, possibly using the same microphone, but according to the present invention, participant identification techniques were able to distinguish the two voices (as will be discussed in more detail with respect to FIG. 2 below). In an exemplary embodiment of the present invention, each speaking participant may be assigned both a graphic cue, as shown at 14, and an audio cue in the form of spatial imaging (as will be discussed in more detail with respect to FIG. 3 below). In such case, the graphic cues at 14 in FIG. 1D may display the geographical locations of the respective participants, as discussed above, and in addition, graphically represent the corresponding virtual spatial location from which the voice of each participant appears to originate according to spatial imaging (to be described in more detail with respect to FIG. 3 below). Similarly, the arrangement of icons 12 representing participants in FIG. 1B may also graphically represent the spatial arrangement of voices in virtual space, if each participant is designated both a graphic cue and an audio cue in the form of spatial imaging.

In another embodiment, the arrangement of graphic cues at 14 in FIG. 1D may graphically represent the geographical distance between each respective participant and the listening party. For example, in FIG. 1D the listening party may be located in Cleveland, Ohio. Therefore, starting from left to right, the closest participant (e.g., Chicago) occupies the left-most location, the furthest participant (e.g., Stockholm) occupies the right-most location, and the remaining participants, (e.g., New York City) respectively occupy the middle two locations. In yet another embodiment, the virtual spatial location assigned to the voice of each respective participant, as provided by spatial imaging, may correlate, in part, to the physical distance between the given participant and the listening party. In such case, the graphic cues at 14 in FIG. 1D may graphically represent two aspects about each participant: 1) the geographical distance between the respective participant and the listening party; and 2) the corresponding virtual spatial location of the voice of the respective participant.

Although only FIGS. 1B and 1D illustrate an example of generating both a graphic cue and an audio cue for each participant, it will be appreciated that any graphic cue can be generated in combination with any audio cue using the principles of the invention. Furthermore, although FIGS. 1A through 1D illustrate specific graphic cues, the present invention is not limited to any particular graphical features (e.g., text, font, color, shape, configuration, etc.), and any and all combinations of the graphic features stated herein or otherwise may be used. For example, in FIGS. 1C and 1D, the speaking participant may be emphasized by highlighting the corresponding label, as in FIGS. 1A and 1B. Conversely, in FIGS. 1A and 1B, the speaking participant may be distinguished by enlarging the name and/or icon of the speaker, as in FIG. 1C. Alternatively, the graphic cue may, for example, flash (e.g., blink on and off) when the corresponding participant is speaking. Moreover, although FIGS. 1A through 1D illustrate an example involving three or four participants (in addition to the listening party), it will be appreciated that any number of participants can be accommodated using the same principles of the invention.

As will be described in more detail below, the particular processing circuitry for carrying out the present invention can be located within a mobile phone or other electronic device. Alternatively, the particular processing circuitry may be included elsewhere, such as in a network server that carries out conventional multi-party communication functions in a telephone or voice-over-internet network.

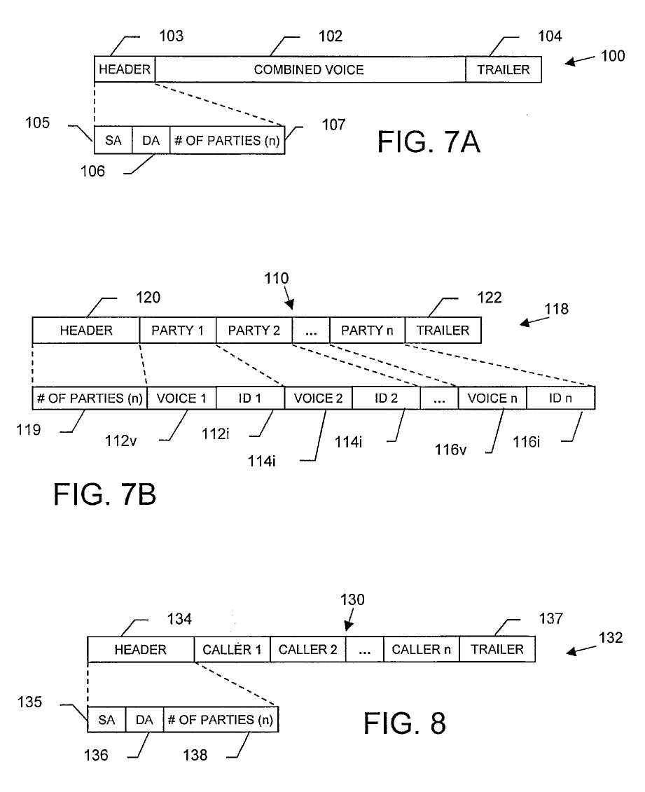

FIG. 2 is a functional block diagram of a multi-party communication enhancer 20 for carrying out the processing and operations briefly described above to discern each participant in a multi-party communication according to the present invention. In an exemplary embodiment, the enhancer 20 may include an amplitude normalizer 22, which receives audio data intended for the listening party from the communication participants. The audio data received by the amplitude normalizer 22 may include voice data from each of the respective communication participants and may also include information relating to which voice data corresponds to which participant, as is explained in more detail with respect to FIGS. 7A, 7B and 8 below. In addition, the audio data may include information relating to the total number of participants in the multi-party communication (in addition to the listening party). Furthermore, the audio data may include caller identification (ID) information (e.g., name, phone number, and/or geographical location) when a conventional caller ID telephony service provides identification information about the participants.

The amplitude normalizer 22 analyzes the amplification level of the voice signals within the audio data received from respective participants and normalizes any difference in amplification within the received voice signals by increasing, or “boosting,” the gain of the lower amplitude voice signals. For example, participants speaking softly or sitting further away from the microphone will produce lower amplitude (e.g., weak) voice signals. The weak voice signals may be boosted with minimal distortion by compensating for the unused “headroom” (e.g., the difference in dB between the maximum, or minimum, physically possible amplitude level and the maximum amplitude level of the received audio signal). Similarly, for example, the gain of higher amplitude (e.g., strong) voice signals, such as those participants speaking loudly and/or sitting close to the microphone, may be decreased, or “cut.” The amplitude normalizer 22 may also include a filter to reduce static and/or various other electrical noise and/or acoustic noise. In the above manner, the exemplary embodiment of the present invention may reproduce the received voice signals at approximately the same volume level, allowing the listening party to hear the communication participants equally well.

According to the exemplary embodiment, the amplitude normalizer 22 may provide the audio data to a participant identifier 24, also included in the multi-party communication enhancer 20. In another embodiment, the received audio data may be provided to the participant identifier 24 first and then to the amplitude normalizer 22 using the principles of the present invention. Alternatively, the amplitude of the voice signals within the received audio data may not be normalized at all, and this would not depart from the scope of the invention.

The participant identifier 24 distinguishes the voices of the respective participants within the combined voice data received at any given time in association with the multi-party communication. In an exemplary embodiment, the participant identifier 24 may include a voice recognizer 26 that may utilize conventional voice recognition technology, which operates in four stages: enrollment, feature extraction, authentication, and decision. For initial explanation purposes, it is assumed that the voice of only one participant is represented in the received voice data. During enrollment, the voice recognizer 26 may record the voice of the speaker and may create an individualized voice template (or model) based on certain acoustic features extracted from the sampled voice. According to the exemplary embodiment, enrollment may occur during the multi-party communication when a participant speaks for the first time, or may occur at any time outside of the communication, for example, at the request of the listening party. In the exemplary embodiment, the voice recognizer 26 may store the voice templates in a memory (not shown) for future retrieval and may assign a corresponding identification (ID) number to each voice template for future identification. In another embodiment, the voice templates and ID numbers may be stored on the network server (not shown) that enables the multi-party communication.

Similar to enrollment, during feature extraction the voice recognizer 26 may extract features from the received voice signal and may use the features to generate a voice model. Conventional feature extraction occurs at each interval of speech (e.g., 10-30 milliseconds) throughout the communication. In the authentication or pattern-matching phase, the voice recognizer 26 may compare the received voice model against all previously stored voice templates to determine whether the speaker is already enrolled in the system. In the decision phase, the voice recognizer 26 may uses the pattern-matching results to decide a “match” or “no match” for the received voice signal. The voice recognizer 26 may decide to re-try the search when the pattern-matching results are inconclusive, such as when overlapping speakers make recognition of each voice difficult. When the voice recognizer 26 decides that the received voice data does not match any of the stored voice templates, the voice recognizer 26 may store the generated voice model as a voice template and the speaking participant may be thus “enrolled” into the voice recognition system.

According to the exemplary embodiment, after a speaker is enrolled or when a match is made, the voice recognizer 26 may provide the received voice data to an identity provider 28, also included in the participant identifier 24. The identity provider 28 may provide speaker identification data for each distinguished voice from a number of sources, including, for example, the received audio data (e.g., caller ID information), the memory of a mobile phone (e.g., phone book information), the voice recognizer 26 (e.g., ID number), the network server that enables the multi-party communication (e.g., meta data and/or audio formatting that provides more precise geographical or positional information), etc. For example, a speaking participant may be enrolled into the voice recognition system prior to the multi-party communication, and have a corresponding name and/or photograph stored in a memory, in which case the speaker identification data includes the name and/or photograph of the participant, as illustrated in FIGS. 1A and 1B. On the other hand, the speaker identification data may be provided by a conventional caller ID service, to the extent that the participant is calling from a discernable phone line, in which case the speaker identification data includes the name, location, and/or phone number of the participant, as illustrated in FIGS. 1A, 1B and 1D.

When the speaker identification data only includes the ID number designated by the voice recognizer 26, the identity provider 28 may arbitrarily assign a speaker label to the participant, as illustrated in FIG. 1C, and store the speaker label in, for example, a memory, along with the corresponding ID number, to facilitate future retrieval for cue generation purposes. The arbitrarily assigned speaker label may be a single character (e.g., number or letter), as shown in FIG. 1C, or it may be a word plus a character, e.g., “Speaker J, Speaker N, etc,” or any other combination of characters. Alternatively or in conjunction with words and characters, the speaker label may be an arbitrarily assigned icon or color.

In an embodiment that does not include the voice recognizer 26, the participant identifier 24 may distinguish the voices of the participants in a multi-party communication by, for example, relying on information provided by a caller ID service and/or the network server that enables the communication. In addition, when participants in one location use separate microphones, the voice data from each microphone may be separately transmitted by that location, and/or the received audio data may include positional information regarding which microphone is associated with a voice data segment. In such cases, the identity provider 28 may provide speaker identification data for each participant based on the information received from the caller ID service and/or network server.

In an alternative embodiment, a determination of who is talking may be made by measuring which one of the parties is “loudest” at the moment. This determination may be made using a conventional volume or amplitude measuring device and may be used instead of or in addition to voice recognition software. This determination may be made before normalizing the voice amplitude, which is described above. If used in addition to voice recognition software, the volume measurement may be used to confirm or to validate the determination made by the voice recognition software. If confirmation is not obtained, then one or the other or both of the voice recognition determination and the voice amplitude determination could be re-run until a definitive determination of who is talking is made.

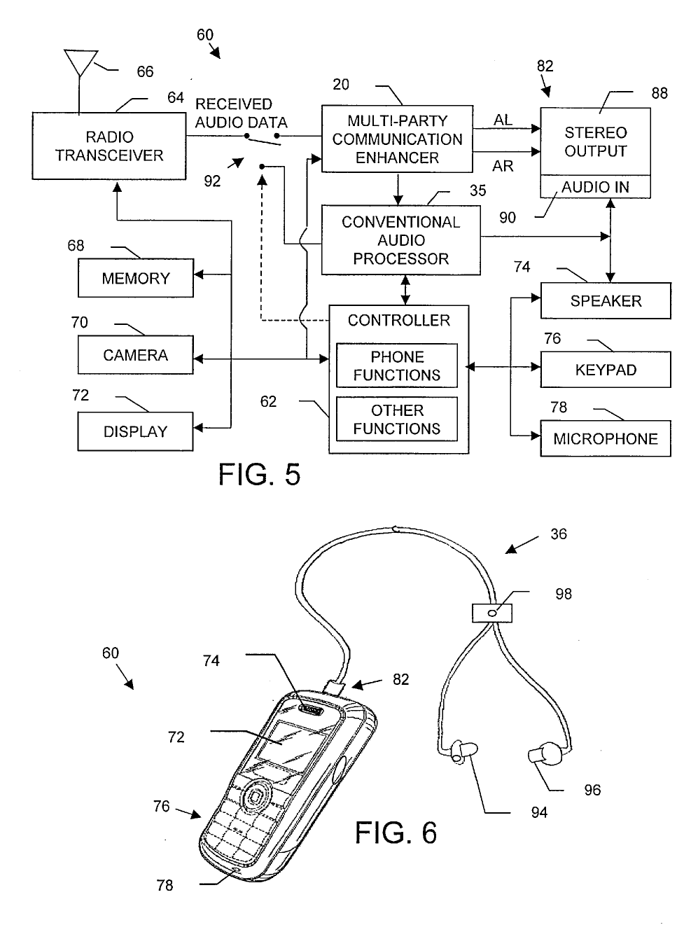

The participant identifier 24 provides the speaker identification data for each participant to a cue generator 30, which generates a cue based on the received identification data. The cue generator 30 then presents the generated cue to the listening party in association with the received voice data. A listening party may select the type(s) of cue(s) generated and the format of each cue for each multi-party communication. The cue generator 30 may include a graphic cue generator 32 that provides a graphic cue to a display 10, as illustrated in FIGS. 1A through 1D. The cue generator 30 may further include an audio cue generator 34 that provides an audio cue to either a conventional audio processor 35 (as shown in FIG. 5) or a multi-channel audio reproduction system (e.g., wired headset 36 as shown in FIG. 6). According to an exemplary embodiment, the cue generator 30 may continuously provide the same cue(s) as long as the voice recognizer 26 continuously recognizes the voices of the same speaking participant. When the voice recognizer 26 detects a different voice, the cue generator 30 may present different cues thereby to indicate the new speaker. In another embodiment, the cue generator 30 may provide the cue one time before and/or as the participant speaks, rather than continuously providing the cue for the entire speech segment. According to yet another embodiment, no cue may be provided when the listening party speaks. Alternatively, a listening party cue may be provided on the display 10 when the listening party speaks.

In accordance with an exemplary embodiment of the present invention, the generated cue for each participant may be a combination of both audio and graphic cues, as illustrated in FIG. 1D, and thus, the identity provider 28 may provide speaker identification data to both the graphic cue generator 32 and the audio cue generator 34. When an audio cue is selected, the participant identifier 24 may also provide the voice data from the respective speaking participants to a voice segmenter 37, also included in the cue generator 30. The voice segmenter 37 segments the voice data into respective data streams (e.g., Party 1, Party 2, etc . . . ) and provides the segmented data streams to the audio cue generator 34 for generating an audio cue for each respective participant to be reproduced in association with the corresponding data stream. The audio cue generator 34 may include, for example, a vocal cue generator 38 for generating a verbal announcement that, for example, names the participant about to speak; a tonal cue generator 39 for generating a tonal announcement identifying the participant about to speak; and/or a multi-party communication spatializer 40 (to be discussed in more detail with respect to FIG. 4 below). When a vocal or tonal cue is generated, a delay may be inserted into the voice data so that the vocal/tonal announcement is provided before the voice of the corresponding participant is reproduced by the conventional audio processor 35 (shown in FIG. 5). In another embodiment where only a graphic cue is selected, all voice data may be sent directly to the conventional audio processor 35 (shown in FIG. 5), as illustrated by the dotted line in FIG. 2.

According to an embodiment of the present invention including a multi-party communication spatializer 40 (to be discussed in more detail with respect to FIG. 4 below), an audio cue generated using multi-channel audio imaging, such as stereo imaging, presents voice data during a multi-party communication to a listening party LP such that the voice of each speaking participant appears to originate from a corresponding spatial location in virtual space from the perspective of the listening party LP. The listening party LP may utilize a multi-channel headset (e.g., wired headset 36 shown in FIG. 6) or other multi-channel audio reproduction arrangement (e.g., multiple audio speakers positioned relative to the listening party) to reproduce the voice data in accordance with the present invention. For purposes of explanation of the present invention, it is assumed, unless otherwise specified, that the received audio data is reproduced using a two-channel audio format. This explanation is exemplary, and it will be appreciated that the invention may be used with other multi-channel audio formats (e.g., 5.1, 7.1, etc.) without departing from the scope of the invention. In such case, spatial imaging is provided in the same manner except over additional audio reproduction channels as is well known.

FIG. 3 is a schematic representation of a virtual spatial arrangement 42 including each of the participants in the communication, where it is assumed that the listening party LP is participating in a multi-party communication involving three additional participants, namely Party 1, Party 2 and Party 3. In the present example, the participants Party 1 thru Party 3 are positioned so as to be equally spaced from one another in a semicircle of radius R originating from the listening party LP as illustrated in FIG. 3. Thus, for example, Party 1 thru Party 3 are equally positioned at angles θ (theta)=45°, 90° and 135° (degrees), respectively, from an axis 44. The axis 44 represents an axis extending through the center of each ear of the listening party LP in accordance with an initial angular orientation of the head of the listening party LP. The radius R can be any value, and may be selected so as to represent a comfortable physical spacing between participants in an actual “in-person” conversation. For example, the radius R may be preselected to be 1.0 meter, but could be any other value as will be appreciated.

The audio cue in the exemplary embodiment of FIG. 3 is generated by using spatial imaging techniques of multi-channel audio to give the listening party LP the audible impression that participants Party 1 thru Party 3 are literally spaced at angles θ=45°, 90° and 135°, respectively, in relation to the listening party LP. Such spatial imaging techniques are based on the virtual distances (e.g., dl, dr) of the participant currently speaking and the left and right ears (46, 48) of the listening party LP. For example, the virtual distance between the left ear 46 of the listening party LP and Party 1 can be represented by dl₄₅°. Similarly, the virtual distance between the right ear 48 of the listening party LP and Party 1 can be represented by dr₄₅°. Likewise, the distances between the left and right ears (46, 48) of the listening party LP and Party 2 can be represented by dl₉₀° and dr₉₀°, respectively. The distances between the left and right ears (46, 48) of the listening party LP and Party 3 can be represented by dl₁₃₅° and dr₁₃₅°, respectively. The left ear 46 and the right ear 48 of the listening party LP are separated from one another by a distance hw corresponding to the headwidth or distance between the ears of the listening party LP. For purposes of explanation of the present invention, the distance hw is assumed to be the average headwidth of an adult, for example. Applying basic and well known trigonometric principles, each of the distances dl and dr corresponding to the participants Party 1 thru Party 3 can be determined easily based on a predefined radius R and headwidth hw.

The virtual distances dl and dr for each of the participants Party 1 thru Party 3 are used to determine spatial gain coefficients applied to the voice data of the respective participants in order to reproduce the voice data of the respective participants to the left and right ears (46, 48) of the listening party LP in a manner that images the corresponding virtual spatial locations of the participants shown at 42 in FIG. 3. In this manner, the listening party LP is provided audibly with a sensation that the actual physical positions of the participants Party 1 thru Party 3 correspond to that shown in FIG. 3. Such sensation enables the listening party LP to differentiate more easily between the particular participants Party 1 thru Party 3 during a multi-party communication, and particularly to differentiate between whom is speaking at any given time.

Although in the exemplary embodiment of FIG. 3 the participants Party 1 thru Party 3 are spatially arranged so as to be equally spaced in a semicircle at radius R, it will be appreciated that the participants may be spatially located in virtual space essentially anywhere in relation to the listening party, including behind the listening party, and/or at different radii R. The present invention is not limited to any particular spatial arrangement in its broadest sense.

FIG. 4 is a functional block diagram of a multi-party communication spatializer 40 for carrying out the processing and operations described briefly above in order to provide spatial positioning of the participants in the multi-party communication according to the exemplary embodiment of the present invention. The spatializer 40 includes a spatial processor 50 that processes the voice data received from the respective participants to provide spatial imaging in accordance with the principles described above. It will be appreciated that the voice data for each participant will typically be single-channel or monaural audio. However, the present invention also has utility when the voice data from a participant is multi-channel, for example stereophonic. The spatial processor 50 separates the voice data of each participant into left and right voice segments and adjusts the amplitude of each voice segment by a corresponding spatial gain coefficient (e.g., al and ar). The spatial processor 50 then outputs voice data for each of the respective participants in the form of left and right audio data (e.g., AL1 to ALn, and AR1 to ARn). The left channel audio data AL1 to ALn from the corresponding participants is input to a left channel mixer 52 included in the spatializer 40 to produce an overall left channel audio signal AL. Similarly, the right channel audio data AR1 to ARn from the corresponding participants is input to a right channel mixer 54 included in the spatializer 40 to produce an overall right channel audio signal AR. The overall left and right channel audio signals AL and AR are then output by the spatializer 40 and provided, respectively, to the left and right speakers of the multi-channel audio reproduction system being used to reproduce the received audio data.

As will be appreciated, the left and right spatial gain coefficients (designated al and ar, respectively) are utilized to adjust the amplitude of the voice data from a given participant as reproduced to the left and right ears of the listening party. By adjusting the amplitude of the voice data reproduced in the respective ears, the voice data is perceived by the listening party as originating from the corresponding spatial location of the participant. Such spatial gain coefficients al and ar for a given spatial location may be defined by one or more equations, for example the logarithmic equations, shown below or some other equations:

al=(e^{-(dr)})/(e^{-(dl)}+e^{-(dr)}) (Equ. 2)

ar=(e^{-(dl)})/(e^{-(dl)}+e^{-(dr)}) (Equ. 3)

As will be appreciated, the spatial gain coefficients al and ar take into account the difference in amplitude between the voice data as perceived by the left and right ears of the listening party LP due to the difference in distances dl and dr from which the voice sound must travel from a given participant to the left and right ears of the listening party in the case where the speaking participant is not positioned directly in front of the listening party.

A look-up table may be suitable for use in the present invention for determining the spatial gain coefficients al and ar in accordance with the particular positions of the participants Party 1 thru Party n. For a given party position, e.g., a participant located at θ=45°, the participant will be located at a virtual distance dl₄₅° from the left ear of the listening party, and a virtual distance dr₄₅° from the right ear of the listening party. Based on such entries in the table, the table may include spatial gain coefficient entries for the left and right audio channels provided to the left and right ears of the listening party used to image the respective participants at their respective locations.

Referring to FIG. 4, the multi-party communication spatializer 40 further includes a party positioner 56 that provides spatial position information (e.g., the value of θ (theta)) for each of the communication participants to the spatial processor 50. In the exemplary embodiment of the present invention, the party positioner 56 places each participant at equally spaced angles relative to the virtual semi-circle originating from the listening party LP as shown in FIG. 3. A look-up table may also be suitable for determining the equally spaced angular positions of the participants Party 1 thru Party n (relative to the listening party). The angular position θ of each of the participants may be defined by, for example, the following equation:

θ_{Partyi}=(180°˜i)/(n+1), where i=1 to n (Equ. 1)

where n equals the number of participants (e.g., Party 1 thru Party n) involved in the multi-party communication (in addition to the listening party). The number of participants (n) may be provided by the participant identifier 24 or may be calculated by the party positioner 56 based on the speaker identification data received from the participant identifier 24. The party positioner 56 may also strive for balance in the sound picture by avoiding the placement of a participant at θ=0° or 180° (degrees) relative to the listening party, because such placement may make listening uncomfortable. In another embodiment, the party positioner 56 may use speaker identification data received from the participant identifier 24 to determine the virtual spatial location of each participant (other than the listening party).

The spatial processor 50 and the party positioner 56 may include processing circuitry for determining the corresponding virtual spatial positions and spatial gain coefficients of the participants in the multi-party communication described above. However, use of look-up tables for obtaining these corresponding spatial positions and gain coefficients avoids the need for processing circuitry to compute such positions and coefficients in real time. This reduces the necessary computational overhead of the multi-party communication spatializer 40. Nonetheless, it will be appreciated that the virtual spatial positions and spatial gain coefficients in another embodiment can easily be calculated by the processing circuitry in real time using the principles described above.

A number of techniques may be used to determine the order in which the participants are spatially positioned; and thus, only a few will be mentioned herein in the interest of brevity. For example, the party positioner 56 may be configured to randomly select the order in which the participants are placed in the virtual spatial arrangement 42 shown in FIG. 3. As another example, the order in which the participants are placed may be associated with the order in which the participants joined the multi-party communication as discussed above with respect to FIGS. 1A through 1C. In still another example, the placement order of the participants may be based on a prefix, such as the location from which the participant is calling, so that the virtual spatial location of each participant correlates with the distance between the listening party and the respective participant, as discussed above with respect to FIG. 1D. Another example would require each participant to enter a separate code, such as a pin number, which would allow a moderator of the multi-party communication to control the spatial location of each participant in virtual space. In each of the above examples, the speaker identification data may include the information required for spatial positioning.

Thus, it will be appreciated that the exemplary embodiment of the present invention enables the voice of each of the participants in the multi-party communication to appear to originate from a corresponding virtual spatial location, providing a listening party with an audio cue that provides spatial cognitive feedback, in addition to the voice of the speaking party and a graphic cue as illustrated in FIG. 1D. The operations and processes of the multi-party communication spatializer 40 of the present invention are provided briefly herein for brevity sake. More detail may be found, for example, in copending U.S. patent application Ser. No. 11/737,837, which is incorporated by reference herein.

It will be appreciated that the various operations and functions described herein in relation to the present invention may be carried by discrete functional elements as represented in the figures, substantially via software running on a microprocessor, or a combination thereof. Furthermore, the present invention may be carried out using primarily analog audio processing, digital audio processing, or any combination thereof. Those having ordinary skill in the art will appreciate that the present invention is not limited to any particular implementation in its broadest sense.

FIG. 5 is a functional block diagram of a mobile phone 60 of a listening party incorporating a multi-party communication enhancer 20 in accordance with the present invention. The mobile phone 60 includes a controller 62 configured to carry out conventional phone functions as well as other functions as described herein. In addition, the mobile phone 60 includes a radio transceiver 64 and antenna 66 as is conventional for communicating within a wireless phone network. In particular, the radio transceiver 64 is operative to receive voice data from one or more parties at the other end(s) of a telephone call(s), and to transmit voice data of the listening party to the other parties in order to permit the listening party to carry out a conversation with the one or more other parties.

Furthermore, the mobile phone 60 includes conventional elements such as a memory 68 for storing application programs, operational code, user data, phone book data, etc. Such conventional elements may further include a camera 70, user display 72, speaker 74, keypad 76 and microphone 78. The mobile phone 60 further includes a conventional audio processor 35 for performing conventional audio processing of the voice data in accordance with conventional telephone communications.

In connection with the particular aspects of the present invention, the mobile phone 60 may include a stereo adaptor 82 for enabling the listening party to connect a wired headset 36 (shown in FIG. 6), or other multi-channel audio reproduction equipment, to the mobile phone 60. In the case where the listening party utilizes the wired headset 36 (shown in FIG. 6) or other wired multi-channel audio speakers (not shown), the stereo adaptor 82 may simply represent a multi-terminal jack into which the headset may be connected via a mating connector (not shown). Alternatively, the headset may be wireless, e.g., a Bluetooth headset with multi-channel audio reproduction capabilities. In such case, the stereo adaptor 82 may be a corresponding wireless interface (e.g., Bluetooth transceiver).

The stereo adaptor 82 in the exemplary embodiment includes a stereo output 88 to which the combined left and right channel audio signals AL and AR from the multi-party communication enhancer 20 are provided. Additionally, in the case of conventional audio operation, the conventional audio signal may be provided to the stereo adaptor 82 from the conventional audio processor 35, as will be appreciated. Finally, the stereo adaptor 82 includes an audio input 90 for receiving voice data from the listening party when the listening party utilizes the wired headset 36 (shown in FIG. 6), or other audio reproduction system that includes its own microphone, separate from the microphone 78 of the mobile phone 60. The voice data received by the audio input 90 is in turn transmitted to the party or parties at the other end of the multi-party communication via the conventional audio processor 35 and the transceiver 64.

In accordance with an exemplary embodiment of the present invention, the listening party may select the type of cue to be generated for each speaking participant by way of a corresponding input in the keypad 76 or other user input. Alternatively, the type of cue to be generated may be fixed during manufacture of the multi-party communication enhancer.

In accordance with an exemplary embodiment, the listening party may select multi-party communication enhancement via the multi-party communication enhancer 20 by way of a corresponding input in the keypad 76 or other user input. Based on whether the listening party selects multi-party communication enhancement in accordance with the present invention, the controller 62 may be configured to control a switch 92 that determines whether the voice data received via the transceiver 64 is processed by the conventional audio processor 35, or via the multi-party communication enhancer 20. In accordance with another embodiment, the controller 62 may be configured to detect whether the voice data received by the transceiver 64 is in an appropriate data format for multi-party communication enhancement as exemplified below with respect to FIGS. 7A, 7B and 8. If the controller 62 detects that the voice data is in appropriate format, the controller 62 may be configured to cause the switch 92 to provide processing by the multi-part communication enhancer 20.

Referring briefly to FIG. 6, shown is a perspective view of the mobile phone 60 of FIG. 5. As illustrated, a headset of the listening party may be a wired headset 36 connected to the stereo adaptor 82 of the mobile phone 60. The headset 36 includes the left speaker 94 for reproducing left channel audio sound into the left ear 46 of the listening party, and a right speaker 96 for reproducing right channel audio sound into the right ear of the listening party. The left and right channel audio signals AL and AR from the multi-party communication spatializer 40 are provided to the corresponding left and right speakers 94, 96 of the listening party headset 36 in order to reproduce the received voice data in accordance with the spatial imaging principles of the present invention. In addition, the headset 36 includes a built-in microphone 98 for providing the audio input signal representing the voice of the listening party during the communication to the stereo adaptor 82. The stereo adapter 82 then provides the received audio input signal to the conventional audio processor 35, as described above. Alternatively, the microphone 78 of the mobile phone 60 may be used to provide the audio input signal to the conventional audio processor 35, instead of the built-in microphone 98 of the headset 36.

As previously noted, the audio data for the respective multi-party communication participants as received by the multi-party communication enhancer 20 may include identification information that is separable from the voice data. There are several ways of carrying out such separation. Accordingly, only a few will be described herein; others may currently exist or may come into existence in the future.

For example, FIG. 7A illustrates a packet format 100 of audio data received by the multi-party communication enhancer 20 of the listening party, where all communication participants (other than the listening party) are calling from the same office and using the same microphone. In the exemplary embodiment, a network server (not shown) or other device responsible for enabling the multi-party communication between the listening party and other participants is configured to receive the voice data from the other participants and to form a combined voice package 102 including the voice data from each of the parties mixed together. The network server or other device then transmits the voice data in such format to the mobile phone 60 or other device incorporating the multi-party communication enhancer 20 in accordance with the present invention.

As is shown in FIG. 7A, each packet of audio data 100 contains a header 103, the combined voice data package 102, and a trailer 104. The voice data for each party as included in a given audio packet may represent a predefined time unit of voice data, with subsequent packets carrying subsequent units of voice data as is conventional. The header 103, as is conventional, includes source address (SA) and destination address (DA) information identifying the address of the network server, for example, as the source address SA 105, and the network address of the mobile phone of the listening party as the destination address DA 106. In addition, however, the header may include information regarding the number of parties (n) 107 participating in the multi-party communication (in addition to the listening party).

Referring also to FIG. 7B, the participant identifier 24, discussed above with respect to FIG. 2, may receive the audio packet 100 and may be configured to distinguish the voice of respective participants represented within the combined voice data 102 and to separate the combined voice data 102 into respective fields 110 for each of the parties Party 1 thru Party n participating in the multi-party communication (in addition to the listening party). When the voice recognizer 26 (shown in FIG. 2) is used to associate the voice data of each participant with a corresponding ID number, as described above, the voice data (e.g., 112v, 114v and 116v) and ID numbers (e.g., 112i, 114i and 116i) of the participants may be packaged in accordance with the format of audio data packet 118 in FIG. 7B. The voice recognizer 26 (shown in FIG. 2) then transmits the audio data packet 118 to the identity provider 28 which receives the audio data packet 118 and uses the ID numbers (112i, 114i and 116i) to retrieve any available speaker identification data from, for example, the memory 68 (shown in FIG. 5), or to assign speaker identification data if none is available, as described above. The participant identifier 24 then transmits the speaker identification data to the graphic cue generator 32 and/or the audio cue generator 34 in accordance with the present invention, as shown in FIG. 2 above. Moreover, still referring to FIG. 7B, the participant identifier 24 (shown in FIG. 2) may provide the information (n) 119, (e.g., indicating the number of parties who are in the multi-party communication) from the header 120 to the party positioner 56 of the multi-party communication spatializer 40 (as described above with respect to FIG. 4), so that the multi-party communication spatializer 40 can process the voice data for reproduction in accordance with the above described operation. In the exemplary embodiment where an audio cue is generated, the participant identifier 24 transmits the voice data (112v, 114v and 116v) to the voice segmenter 37 of the cue generator 30 to provide audio cues (e.g., tonal, vocal, or spatial) for the respective participants as discussed above with respect to FIG. 2. In another embodiment where only a graphic cue is generated, the participant identifier 24 transmits the voice data (112v, 114v and 116v) to the conventional audio processor 35 as discussed above with respect to FIG. 2.

Referring now to FIG. 8, when communication participants are calling from multiple office locations, the network server or other device may be configured to receive audio data from each calling location and package the audio data into separate respective fields 130 for each of the locations Caller 1 thru Caller n (in addition to the listening party). An exemplary packet of audio data in such format, shown at 132, includes a header 134, which again has a source address SA 135, a destination address DA 136, and number of participants (n) 138; the voice data in respective fields 130; and a trailer 137. In accordance with this embodiment, the participant identifier 24 (shown in FIG. 2) receives the audio data packet 132, and the voice recognizer 26 (shown in FIG. 2) analyzes the voices and inserts a corresponding ID number into each respective voice field, as exemplified by the format shown at 118 in FIG. 7B, before transmitting the audio data packet to the identity provider 28 (shown in FIG. 2) for designation of speaker identification data as described above. If more than one communication participant is present at a given office location, the voice data for all participants from that location would be combined into one of the voice fields 130 of the audio data packet 132. The voice recognizer 26 (shown in FIG. 2) receives the voice data in such format and distinguishes between the voices of the respective participants at each location. The voice recognizer 26 then separates the voice data into respective fields and inserts the corresponding ID numbers according to the format shown at 118 of FIG. 7B, before transmitting the audio data packet to the identity provider 28 (shown in FIG. 2) as described above.

In another embodiment, the participant identifier 24 (shown in FIG. 2) may be configured to detect the number (n) of communication participants simply by analyzing the number of voice data fields included in an audio data package. In such case, the header need not include such specific information. In yet another embodiment, the audio data may include identification information, e.g., caller ID, for each of the callers and/or participants. In such case, the audio data may be formatted according to the audio data packet 118 in FIG. 7B and the identification information may be included within the ID field (e.g., 112i, 114i, 116i).

It will be appreciated that the amount of audio data and/or the necessary bandwidth for transmitting the audio data to the multi-party communication enhancer 20 will depend largely on the particular approach. For example, a large amount of additional bandwidth would be required in an alternative embodiment where a network server provides the voice data of each multi-party communication participant in the form of discrete channels of voice data. However, with the latest generations of mobile networking, sufficient bandwidth is readily available for use in accordance with the present invention. On the other hand, in the case of FIGS. 7A, 7B and 8, very little additional bandwidth is required compared to conventional communications as will be appreciated.

In addition, it will be appreciated that the listening party can represent a multi-party communication participant with regard to any of the other participants in the multi-party communication provided any of those other participants utilize the features of the invention. Alternatively, the other participants instead may simply rely on conventional monaural sound reproduction during the multi-party communication.

The term “multi-party communications” as referred to herein includes all types of communications in which there are two or more speakers. The term “communications” as referred to herein includes phone calls and live or recorded conversations, e.g., talks, seminars, meetings or the like. While the present invention is described herein primarily in the context of a conference call, it will be appreciated that the invention has equal applicability to any type of multi-party communication. For example, the same principles may be applied to an audio recording, streaming audio over the internet, etc.

The term “mobile device” as referred to herein includes portable radio communication equipment. The term “portable radio communication equipment,” also referred to herein as a “mobile radio terminal,” includes all equipment such as mobile phones, pagers, communicators, e.g., electronic organizers, personal digital assistants (PDAs), smartphones or the like. While the present invention is described herein primarily in the context of a mobile device, it will be appreciated that the invention has equal applicability to any type of electronic device providing multi-party communications. For example, the same principles may be applied to conventional landline telephones, voice-over-internet (VoIP) devices, media players, computers etc.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in functional block diagrams may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the functional block diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that any appropriate computer code could be prepared by a person who has ordinary skill in the art to carry out the various steps and procedures described above and illustrated in the drawings. It also will be appreciated that the various terminals, computers, servers, networks, electronic devices and the like described above may be virtually any type and that the computer code may be prepared to carry out the invention using such apparatus in accordance with the disclosure hereof.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A multi-party communication enhancer, comprising:
an audio data input adapted to receive voice data associated with a plurality of communication participants;
a participant identifier adapted to distinguish the voice of a number of communication participants as represented within the received voice data; and
a cue generator operable to generate a cue for each distinguished voice, the generated cue being outputted in association with the corresponding distinguished voice.

2. The multi-party communication enhancer of claim 1, further comprising: an amplitude normalizer adapted to selectively normalize the volume level of said received voice data.

3. The multi-party communication enhancer of claim 1, wherein the participant identifier comprises a voice recognizer.

4. The multi-party communication enhancer of claim 1, wherein the cue generator comprises at least one of a graphic cue generator or an audio cue generator.

5. The multi-party communication enhancer of claim 4, wherein said audio cue generator comprises a multi-party communication spatializer adapted to generate an audio cue that provides a virtual spatial location from which the corresponding distinguished voice appears to originate when reproduced; and said graphic cue generator generates a graphic cue that graphically represents the corresponding virtual spatial location provided by said audio cue.

6. The multi-party communication enhancer of claim 4, wherein said audio cue generator generates an audio cue that is at least one of a vocal cue or a tonal cue; and said graphic cue generator generates a graphic cue that is at least one of a character, a combination of characters, an icon, or a color.

7. The multi-party communication enhancer of claim 4, wherein said graphic cue generator provides a graphic cue for each communication participant and at least one of the provided graphic cues is highlighted to indicate which communication participant is speaking.

8. The multi-party communication enhancer of claim 1, wherein said participant identifier designates speaker identification data for each distinguished voice to provide the corresponding cue.

9. The multi-party communication enhancer of claim 8, wherein said speaker identification data is at least one of user-provided data, data assigned by said participant identifier, data received in association with said received voice data, data regarding the time of joining the multi-party communication, data regarding the order in which the voice was distinguished by said participant identifier, or data regarding the number of participants in the multi-party communication.

10. A method for discerning respective participants in a multi-party communication, including:
receiving voice data associated with a plurality of communication participants;
distinguishing the voice of a number of the communication participants as represented within the received voice data;
correspondingly generating a cue for each distinguished voice; and
outputting the generated cue in association with the corresponding distinguished voice.

11. The method of claim 10, further including: selectively normalizing the volume level of said received voice data.

12. The method of claim 10, wherein said distinguishing the voice of a number of communication participants comprises using voice recognition technology.

13. The method of claim 10, wherein said correspondingly generating a cue comprises generating at least one of a graphic cue or an audio cue.

14. The method of claim 13, wherein said generating an audio cue comprises providing a virtual spatial location from which the corresponding distinguished voice appears to originate when reproduced; and said generating a graphic cue comprises graphically representing the corresponding virtual spatial location provided by said audio cue.

15. The method of claim 10, wherein said distinguishing the voice of a number of communication participants comprises designating speaker identification data for each distinguished voice to provide the corresponding cue.

16. The method of claim 15, wherein said designating speaker identification data comprises providing at least one of user-provided data, data assigned by a participant identifier, data received in association with said received voice data of the multi-party communication, data regarding the time of joining the multi-party communication, data regarding the order in which the voice was distinguished, or data regarding the number of participants in the multi-party communication.

17. An electronic device, comprising:
an audio data receiver adapted to receive voice data associated with a plurality of communication participants; and
the multi-party communication enhancer of claim 1, wherein the received voice data is input to said multi-party communication enhancer.

18. The electronic device of claim 17, further comprising: at least one of a conventional audio processor, a stereophonic audio system, or a display.

19. The electronic device of claim 18, further comprising: an amplitude normalizer adapted to selectively normalize the volume level of said received voice data.

20. The electronic device of claim 18, wherein said participant identifier comprises a voice recognizer.

21. The electronic device of claim 18, wherein said cue generator comprises at least one of a graphic cue generator or an audio cue generator.

22. The electronic device of claim 21, wherein the audio cue generator comprises a multi-party communication spatializer adapted to generate an audio cue that provides a virtual spatial location from which the corresponding distinguished voice appears to originate when reproduced; and said graphic cue generator generates a graphic cue that graphically represents the corresponding virtual spatial location provided by said audio cue.

23. The electronic device of claim 18, wherein said participant identifier designates speaker identification data for each distinguished voice to provide the corresponding cue.

24. The electronic device of claim 23, wherein said speaker identification data is at least one of user-provided data, data assigned by said participant identifier, data received in association with said received voice data of the multi-party communication, data regarding the time of joining the multi-party communication, data regarding the order in which the voice was distinguished by said participant identifier, or data regarding the number of participants in the multi-party communication.

25. The electronic device of claim 18, wherein said electronic device is a mobile phone.
